(19) United States
(12) Patent Application Publication
(10) Pub. No.: US 2017/0102952 A1
(43) Pub. Date: Apr. 13, 2017

(54) ACCESSING DATA STORED IN A REMOTE TARGET USING A BASEBOARD MANAGEMENT CONTROLER (BMC) INDEPENDENTLY OF THE STATUS OF THE REMOTE TARGET'S OPERATING SYSTEM (OS)

(71) Applicant: Dell Products, L.P., Round Rock, TX (US)

(72) Inventors: Lucky Pratap Khemani, Bangalore (IN); Chitrak Gupta, Bangalore (IN); Neeraj Joshi, Puducherry (IN)

(73) Assignee: Dell Products, L.P., Round Rock, TX (US)

(21) Appl. No.: 14/876,990

(22) Filed: Oct. 7, 2015

(51) Int. Cl. G06F 9/44; G06F 3/06; G06F 13/42

(52) U.S. Cl. CPC G06F 9/4411; G06F 13/4282; G06F 3/0689; G06F 3/0619; G06F 3/0665; G06F 9/4406

(57) ABSTRACT

Systems and methods for accessing data stored in a remote target using a Baseboard Management Controller (BMC) and independently of the status of the remote target's Operating System (OS). In some embodiments, a BMC of an Information Handling System (IHS) may have program instructions stored thereon that, upon execution, cause the IHS to: communicate with another BMC of another IHS over a network; and access a storage device of the other IHS through the other BMC via the network while the other IHS operates without any OS. In other embodiments, a method may include determining, by a first IHS, that a second IHS is operating without any OS; and sending, by a first BMC within the first IHS to a second BMC within the second IHS, an access request directed to a virtual drive of the second IHS.

### FIELD

This disclosure relates generally to computer systems, and more specifically, to systems and methods for accessing data stored in a remote target using a Baseboard Management Controller (BMC) and independently of the status of the remote target's Operating System (OS).

### BACKGROUND

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, global communications, etc. In addition, IHSs may include a variety of hardware and software components that may be configured to process, store, and communicate information and may include one or more computer systems, data storage systems, and networking systems.

In some cases an IHS may include data storage in the form of a disk array, as well as a component called a “disk array controller,” which is configured to enable the IHS to use one or more disk arrays as storage.

As the inventors have recognized, when two or more IHSs are connected via a network, a user cannot perform a memory read or write operation from one IHS to the disk array of the other IHS (using the other IHSs' disk array controller) unless the other IHS is executing an Operating System (OS). If the user wants to read or write data to a remote IHSs' disk array and the remote IHS (also know as a “target”) does not have any OS installed or simply has not been able to boot into its OS, the read or write action cannot be performed. In most situations, the user needs to wait for the target to boot up and then try to access that system. But the target IHS may be down for a number of reasons, including OS corruption, processor failure, system memory failure, and/or potentially other components' failure or network problems.

To address these, and other problems, the inventors have developed systems and methods for accessing data stored in a remote target using a Baseboard Management Controller (BMC) and independently of the status of the remote target's OS.

### SUMMARY

Embodiments of systems and methods for accessing data stored in a remote target using a Baseboard Management Controller (BMC) and independently of the status of the remote target's Operating System (OS) are described herein. In an illustrative, non-limiting embodiment, a BMC of an Information Handling System (IHS) may have program instructions stored thereon that, upon execution, cause the IHS to communicate with another BMC of another IHS over a network; and access a storage device of the other IHS through the other BMC via the network while the other IHS operates without any OS.

In some cases, the BMC may be configured to communicate with the other BMC bypassing the other IHS' Central Processing Unit (CPU). The other BMC may be configured to transmit a read or write command issued by the BMC to a disk array controller of the other IHS. The disk array controller may be configured to execute the read or write command with respect to a plurality of virtual drives maintained by the other IHS. The read or write command may be transmitted to the disk array controller using the Management Component Transport Protocol (MCTP). Additionally or alternatively, the read or write command may be transmitted to the disk array controller via a Management Engine (ME) using a PCIe Vendor Defined Message (VDM).

The BMC may include a Network Block Device (NBD) client, the other BMC may include an NBD server, and the NBD client may be configured to create a virtual hard drive on the IHS that corresponds to a physical hard drive on the other IHS. In addition, the BMC may include a Transmission Control Protocol/Internet Protocol (TCP/IP) network stack.

The program instructions, upon execution, may further cause the IHS to: communicate with yet another BMC of yet another IHS over the network; and access a storage device of the yet another IHS through the yet another BMC via the network while the yet another IHS operates without any OS.

In another illustrative, non-limiting embodiment, an IHS may include a BMC distinct from any processor; and a memory coupled to the BMC and having program instructions stored thereon that, upon execution by the BMC, cause the IHS to: communicate with a plurality of other BMCs of a plurality of other IHSs; and enable a user access to a plurality of storage devices coupled to the other IHS independently of the status of the other IHS's OSs.

The BMC may be configured to communicate with the other BMCs bypassing the other IHS' CPUs. The other BMCs may each be configured to transmit a read or write command issued by the BMC to a disk array controller of its respective IHS. The disk array controller may be configured to execute the read or write command with respect to a plurality of virtual drives. The read or write command may be effected using MCTP. The read or write command may be effected via an ME using a PCIe VDM.

The BMC may include a Network Block Device (NBD) client, wherein the other BMCs each may include an NBD server, and the NBD client may be configured to create virtual hard drives on the IHS that correspond to physical hard drives on the other IHSs. Also, the BMC may include a TCP/IP network stack.

In yet another illustrative, non-limiting embodiment, a method may include determining, by a first IHS, that a second IHS is operating without any OS; and sending, by a first BMC within the first IHS to a second BMC within the second IHS, an access request directed to a virtual drive of the second IHS, wherein the second BMC is configured to effect the access request without using any CPU of the second IHS. The access request may be effected using MCTP or via an ME using a PCIe VDM. The first BMC may include an NBD client, the second BMC may include an NBD server, and the NBD client may be configured to create a virtual hard drive on the first IHS that corresponds to a physical hard drive on the second IHS.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 is a block diagram of an example of a system configured for accessing data stored in a remote target using a Baseboard Management Controller (BMC) and independently of the status of the remote target's Operating System (OS) according to some embodiments.

FIG. 2 is a block diagram of an example of a system for accessing data stored in a remote target according to some embodiments.

FIG. 3 is a block diagram of an example of a system for accessing data stored in a remote target using both a Baseboard Management Controller (BMC) and a host Operating System (OS) according to some embodiments.

FIG. 4 is a block diagram of an example of a system for accessing data stored in a remote target using BMCs without any host OS according to some embodiments.

FIG. 5 is a block diagram of an example of a system for accessing data stored in a remote target using a Network Block Device (NBD) client and server architecture according to some embodiments.

FIG. 6 is a block diagram of an example of a system for accessing data stored in a remote target using a Small Computer System Interface (SCSI) according to some embodiments.

FIG. 7 is a block diagram of an example of a group management system according to some embodiments.

### DETAILED DESCRIPTION

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory.

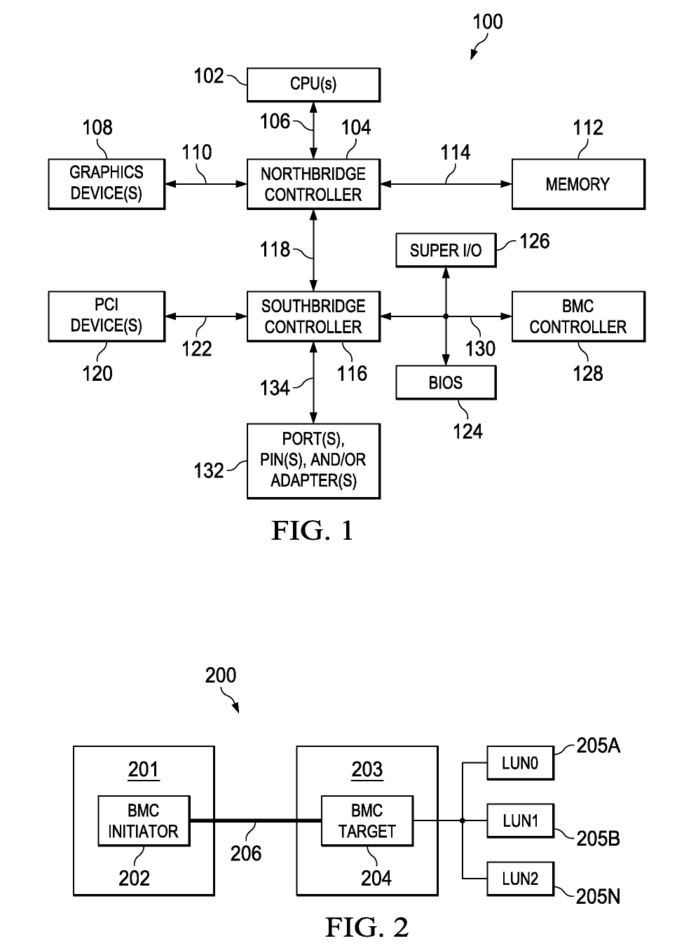

Additional components of an IHS may include one or more disk drives, one or more network ports for communicating with external devices as well as various I/O devices, such as a keyboard, a mouse, touchscreen, and/or a video display. An IHS may also include one or more buses operable to transmit communications between the various hardware components. An example of an IHS is described in more detail in FIG. 1.

FIG. 1 is a block diagram an example of IHS 100 configured to access data stored in a remote target using a Baseboard Management Controller (BMC) independently of the status of the remote target's Operating System (OS). As shown, computing device 100 includes one or more CPUs 102. In various embodiments, computing device 100 may be a single-processor system including one CPU 102, or a multi-processor system including two or more CPUs 102 (e.g., two, four, eight, or any other suitable number). CPU(s) 102 may include any processor capable of executing program instructions. For example, in various embodiments, CPU(s) 102 may be general-purpose or embedded processors implementing any of a variety of instruction set architectures (ISAs), such as the x86, POWERPC®, ARM®, SPARC®, or MIPS® ISAs, or any other suitable ISA. In multi-processor systems, each of CPU(s) 102 may commonly, but not necessarily, implement the same ISA. In an embodiment, a motherboard (not shown) may be configured to provide structural support, power, and electrical connectivity between the various components illustrated in FIG. 1.

CPU(s) 102 are coupled to northbridge controller or chipset 104 via front-side bus 106. Northbridge controller 104 may be configured to coordinate I/O traffic between CPU(s) 102 and other components. For example, in this particular implementation, northbridge controller 104 is coupled to graphics device(s) 108 (e.g., one or more video cards or adaptors, etc.) via graphics bus 110 (e.g., an Accelerated Graphics Port or AGP bus, a Peripheral Component Interconnect or PCI bus, etc.). Northbridge controller 104 is also coupled to system memory 112 via memory bus 114. Memory 112 may be configured to store program instructions and/or data accessible by CPU(s) 102. In various embodiments, memory 112 may be implemented using any suitable memory technology, such as static RAM (SRAM), synchronous dynamic RAM (SDRAM), nonvolatile/Flash-type memory, or any other type of memory.

Northbridge controller 104 is coupled to southbridge controller or chipset 116 via internal bus 118. Generally, southbridge controller 116 may be configured to handle various of computing device 100's I/O operations, and it may provide interfaces such as, for instance, Universal Serial Bus (USB), audio, serial, parallel, Ethernet, etc., via port(s), pin(s), and/or adapter(s) 132 over bus 134. For example, southbridge controller 116 may be configured to allow data to be exchanged between computing device 100 and other devices, such as other IHSs attached to a network. In various embodiments, southbridge controller 116 may support communication via wired or wireless general data networks, such as any suitable type of Ethernet network, for example; via telecommunications/telephony networks such as analog voice networks or digital fiber communications networks; via storage area networks such as Fiber Channel SANs; or via any other suitable type of network and/or protocol.

Southbridge controller 116 may also enable connection to one or more keyboards, keypads, touch screens, scanning devices, voice or optical recognition devices, or any other devices suitable for entering or retrieving data. Multiple I/O devices may be present in computing device 100. In some embodiments, I/O devices may be separate from computing device 100 and may interact with computing device 100 through a wired or wireless connection. As shown, southbridge controller 116 is further coupled to one or more PCI devices 120 (e.g., modems, network cards, sound cards, video cards, etc.) via PCI bus 122. Southbridge controller 116 is also coupled to Basic I/O System (BIOS) 124, Super I/O Controller 126, and Baseboard Management Controller (BMC) 128 via Low Pin Count (LPC) bus 130.

BIOS 124 includes non-volatile memory having program instructions stored thereon. Those instructions may be usable CPU(s) 102 to initialize and test other hardware components and/or to load an Operating System (OS) onto computing device 100. As such, BIOS 124 may include a firmware interface that allows CPU(s) 102 to load and execute certain firmware, as described in more detail below. In some cases, such firmware may include program code that is compatible with the Unified Extensible Firmware Interface (UEFI) specification, although other types of firmware may be used.

BMC controller 128 may include non-volatile memory having program instructions stored thereon that are usable by CPU(s) 102 to enable remote management of computing device 100. For example, BMC controller 128 may enable a user to discover, configure, and manage BMC controller 128, setup configuration options, resolve and administer hardware or software problems, etc. Additionally or alternatively, BMC controller 128 may include one or more firmware volumes, each volume having one or more firmware files used by the BIOS' firmware interface to initialize and test components of computing device 100.

In various implementations, BMC 128 may be a specialized service processor that monitors the physical state of a computer, network server or other hardware device using sensors and communicating with the system administrator through an independent connection. As a non-limiting example of BMC 128, the integrated Dell Remote Access Controller (iDRAC) from Dell® is embedded within Dell PowerEdge™ servers and provides functionality that helps information technology (IT) administrators deploy, update, monitor, and maintain servers with no need for any additional software to be installed. The Dell iDRAC works regardless of operating system or hypervisor presence because from a pre-OS or bare-metal state, iDRAC is ready to work because it is embedded within each server from the factory.

Super I/O Controller 126 combines interfaces for a variety of lower bandwidth or low data rate devices. Those devices may include, for example, floppy disks, parallel ports, keyboard and mouse, temperature sensor and fan speed monitoring, etc.

In some cases, computing device 100 may be configured to access different types of computer-accessible media separate from memory 112. Generally speaking, a computer-accessible medium may include any tangible, non-transitory storage media or memory media such as electronic, magnetic, or optical media—e.g., magnetic disk, a hard drive, a CD/DVD-ROM, a Flash memory, etc. coupled to computing device 100 via northbridge controller 104 and/or southbridge controller 116.

The terms “tangible” and “non-transitory,” as used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

A person of ordinary skill in the art will appreciate that computing device 100 is merely illustrative and is not intended to limit the scope of the disclosure described herein. In particular, any computer system and/or device may include any combination of hardware or software capable of performing certain operations described herein. In addition, the operations performed by the illustrated components may, in some embodiments, be performed by fewer components or distributed across additional components. Similarly, in other embodiments, the operations of some of the illustrated components may not be performed and/or other additional operations may be available.

For example, in some implementations, northbridge controller 104 may be combined with southbridge controller 116, and/or be at least partially incorporated into CPU(s) 102. In other implementations, one or more of the devices or components shown in FIG. 1 may be absent, or one or more other components may be added. Accordingly, systems and methods described herein may be implemented or executed with other computer system configurations.

A person of ordinary skill will recognize that the computer system 100 of FIG. 1 is only one example of a system in which the present embodiments may be utilized. Indeed, the present embodiments may be used in various electronic devices, such as network router devices, televisions, custom telecommunications equipment for special purpose use, etc. The present embodiments are in no way limited to use with the computer system of FIG. 1.

FIG. 2 is a block diagram of an example of system 200 for accessing data stored in a remote target according to some embodiments. Initiating IHS 201 is in communication with target IHS 203 via Local Area Network (LAN) 206. Particularly, BMC initiator 202 is configured to send and receive messages to and from BMC target 204, and independently of the OS status of target IHS 203 or its CPU (not shown). Target IHS 204 is coupled to a plurality of storage devices 205A-N, each identified by a respective Logical Unit Number (LUN).

If it used conventional methods, initiating IHS 201 would, for example, send an SCSI command to target IHS 203 (e.g., mode sense, inquiry, read, report LUNs, etc.). The OS of target IHS 203 would process the command and send an I/O request using disk array controller drivers to a disk array controller of IHS 203, and the controller would write to any virtual disks' associated physical disks 205A-N. As previously noted, however, anytime the target IHS 203 does not have an OS, physical disks 205A-N become inaccessible to initiating IHS 201.

With the architecture of FIG. 2, however, it is BMC initiator 202 of IHS 201 that communicates directly with BMC target 204 of IHS 203, independently of the status of IHS 203's OS. Accordingly, using the various systems and methods described herein, BMC 202 can send an I/O request to BMC target 204, which can then access physical disks 205A-N even when the target OS is down (or non-existent).

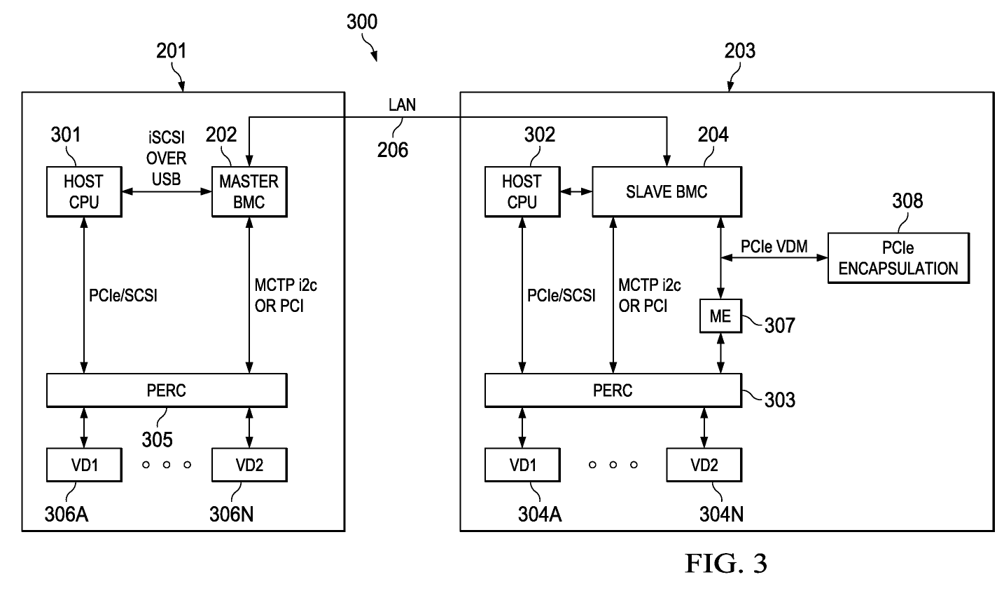

FIG. 3 is a block diagram of an example of system 300 for accessing data stored in a remote target using both a BMC and a host OS according to some embodiments. As shown, master IHS 201 has host CPU 301 and master BMC 202 coupled via an Internet Small Computer System Interface (iSCSI) over Universal Serial Bus (USB), and slave IHS 203 also has host CPU 302 and slave BMC 204 coupled via an iSCSI over USB bus.

In various embodiments, master BMC 202 and slave 203 may each be implemented as a system-on-chip (SOC). Master BMC 202 may implement a network block device (NBD) client, whereas slave BMC 204 may implement an NBD server.

Host CPU 301 of master IHS 201 is coupled to disk array controller 305, here illustrated as a PowerEdge Redundant Array of Independent Disks (RAID) Controller (PERC), via a PCI express (PCIe) or SCSI bus, and master BMC 202 is coupled to PERC 305 over an Inter-Integrated Circuit (I²C) bus using the Management Component Transport Protocol (MCTP). Similarly, host CPU 302 of slave IHS 203 is coupled to PERC 303 via a PCIe or SCSI bus and slave BMC 204 is coupled to PERC 303 over an I²C bus using the MCTP protocol, as well as over a PCI bus via Management Engine (ME) interface 307 using PCIe Vendor Defined Messages (VDMs) and PCI encapsulation module 308.

PERC 303 of slave IHS 204 has access to any number of virtual disks 304A-N, and PERC 305 of master IHS 201 has access to any number of virtual disks 306A-N. In some implementations, master IHS 201 may maintain its own virtual disks 306A-N. More generally, however, master BMC 202 is configured to issue memory access commands directly to slave BMC 204 over LAN 206, and those commands are executed by PERC 303 with results returned to master BMC 202 without intervention by host CPU 302, and therefore independently of the status of IHS 203's OS.

In some cases, PERC 303 may be used to provide virtual storage to master IHS 201. Additionally or alternatively, master 201 may provide a user access to PERC 303 (and therefore VDs 304A-N) when the OS of IHS 203 is down.

In various implementations, Linux NBD drivers allow the creation of a virtual hard drive on a local machine that represents the physical hard drive on the remote machine. As such, in some configurations, an NBD server and NBD client may be installed in slave BMC 204 and master BMC 202, respectively. Conversely, in a group manager mode discussed below, an NBD client may be enabled in master BMC 202 and an NBD server may be enabled in slave BMC 204.

For sending device data over a network using the NBD protocol, an NBD server user application may run on the IHS where the virtual drive or file resides. This can be achieved, for example, by writing NBD server application as a thread. Through Virtual library API and device driver, a virtual drive or file can then be accessed.

Conversely, an NBD client may be enabled in BMC kernel configuration. This will emulate a block device /dev/nb0. This device can be accessed via a user application. A BMC NBD client may establish a connection with the actual device or file using, for example, a command: nbd-client [BMC_Server_IP] [Portno] /dev/nbd0. The NBD-client user application provides necessary infrastructure to negotiate a connection with the server running on the machine where the actual device or file is present and it facilitates the data read and write operations. In some cases, the BMC NBD device can be mounted as virtual USB device to the host system as the BMC USB bus is hard wired to host USB subsystem. The virtual device will be available to host OS as if it were a local device.

Still referring to FIG. 3, MCTP over PCIe enables high bandwidth management traffic to be multiplexed over PCIe busses (i.e., interconnect fabric and/or PCIe links). Internally, the host OS locks the PCIe bridge for I/O traffic during I/O transfer. MCTP traffic takes over the PCIe data path when there is no I/O transfer (multiplexed).

In system 300, the OS is down, so BMC 204 gets most of time PCIe data path for PCIe VDM. Only MCTP message overhead latency is involved in the overall transfer. Logic may be implemented for creating blocks from groups of MCTPD packets. For NBD and iSCSI, PCIe VDM will emulate as PCIe block transfers.

On the side of master BMC 201, if the OS is operational, the PCIe data path may be selected instead of the PCI VDM path to increase overall performance and decrease latency.

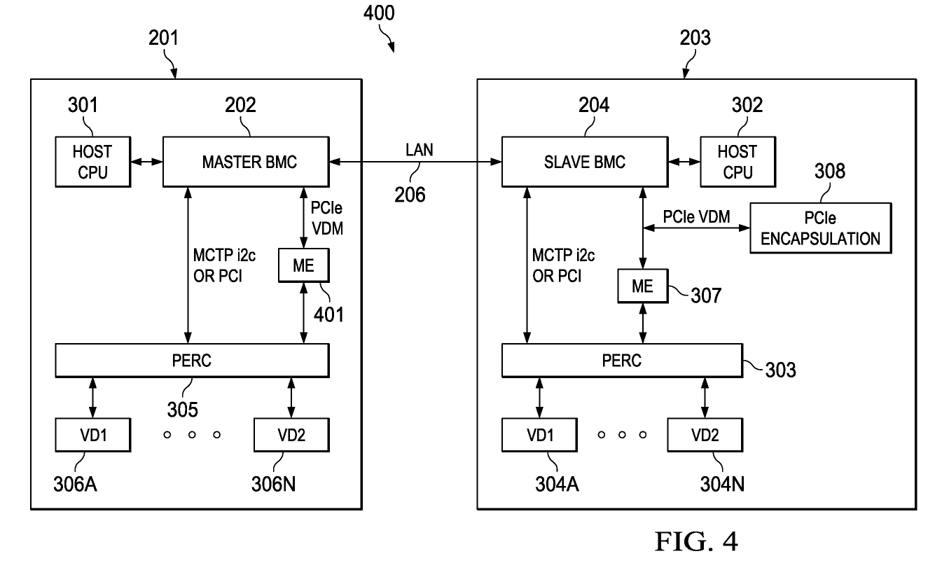

FIG. 4 is a block diagram of an example of system 400 for accessing data stored in a remote target using BMCs without any host OS according to some embodiments. In various embodiments, system 400 is similar to system 300 of FIG. 3, but there is no involvement by any host OS. That is, unlike in system 300, here system 400 does not rely upon PCIe/SCSI communications between host CPUs 301 and 302 and PERCs 303 and 305. Moreover, master BMC 202 is further configured to communicate with PERC 305 via ME interface 401 using PCIe VDMs.

Examples of management engine interfaces 401 and 307 include, but are not limited to, the Intel® Management Engine. In many implementations, ME interfaces 401 and 307 are accessible to BMC 203 without help from CPU 302 or the IHS's OS. On the side of master BMC 201, the PCI VDM path is also selected to make the system entirely independent of any OS.

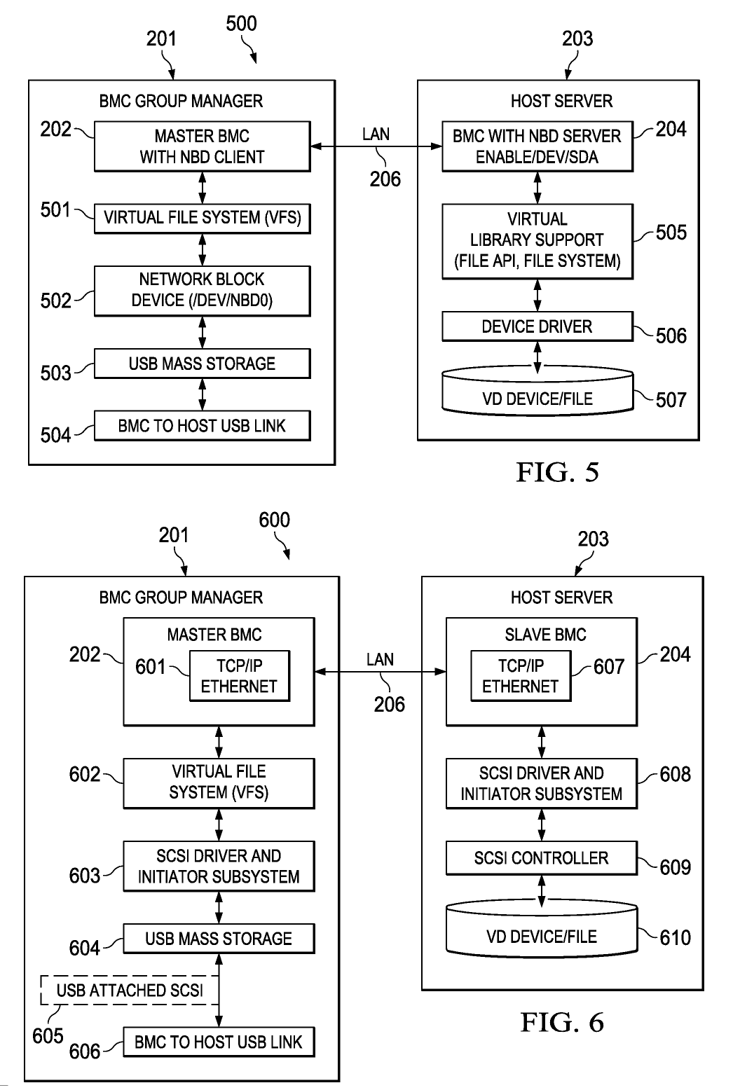

FIG. 5 is a block diagram of an example of system 500 for accessing data stored in a remote target using an NBD client and server architecture according to some embodiments. Particularly, master IHS 201 operates as group manager, described in more detail in connection with FIG. 7 below. As such, master BMC 202 of master IHS 201 executes an NBD client and access virtual file system (VFS) 501, which in turn is coupled to network block device 502, coupled to USB mass storage 503 and BMC to host USB link 504.

Slave BMC 204 of slave IHS 203 (“host server”) executes an NBD server and accesses virtual library support 505 (e.g., file Application Programming Interface or API, file system, etc.), device driver 506, and VD device or file 507. As illustrated, messages between BMC 204 and VD device 507 may be exchanged over a PCIe or SCSI bus.

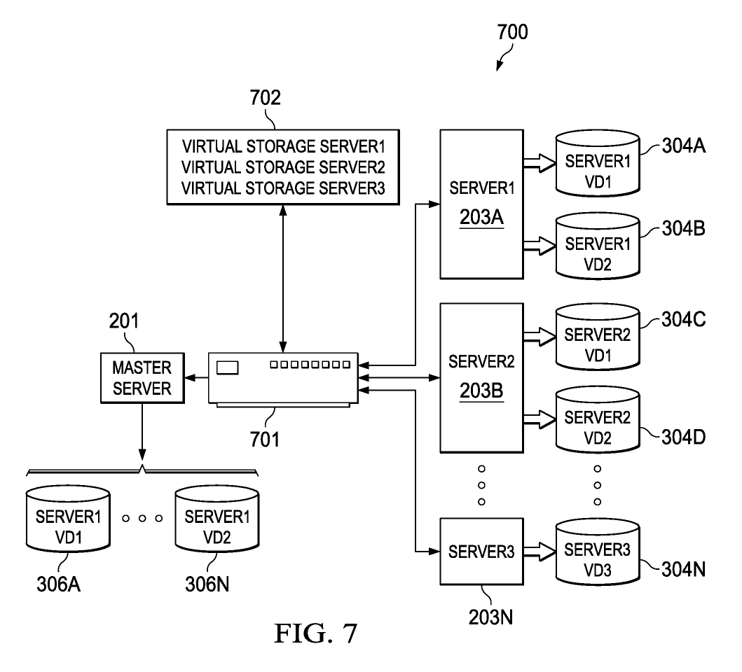

FIG. 6 is a block diagram of an example of system 600 for accessing data stored in a remote target using an SCSI interface. In this embodiment, master BMC of master IHS 201, also operating as a group manager, implements a Transport Control Protocol/Internet Protocol/Ethernet stack 601 to communicated directly with slave BMC 204, which implements a similar stack 607, via LAN 206.

Master BMC 202 is coupled to VFS 602, which is coupled to SCSI driver and initiator subsystem 603, which in turn is coupled to USB mass storage 604, and which provides a USB attached SCSI storage 605 via BMC to Host UBS link 606. Slave BMC 204 is coupled to SCSI driver and initiator subsystem 608 and to SCSI controller 609, which interfaces with VD device or file 610.

FIG. 7 is a block diagram of an example of group management system 700 according to some embodiments. As illustrated, master IHS is coupled to slave IHSs 203A-N. via a network, here illustrated by switch 701. As in previous implementations, each of slave IHSs 203A-N has a plurality or virtual disks 304A-N, and master IHS 201 has its own virtual disks 306A-N. Moreover, a user may access any of virtual disks 304A-N via a user interface provided by a user device 702 in communication with master IHS 201, also via switch 701.

In various embodiments, a BMC Group Manager feature may offer simplified basic management of BMCs and associated servers on the same local network. In operation, master IHS 201 provides a one-to-many console experience without the need to install and maintain software on a dedicated server. Users may turn on this feature via the BMC's graphical user interface (GUI) to automatically discover other BMC nodes, and to list them and their associated server inventory and health status in a consolidated view.

To illustrate the foregoing systems and methods, consider a first scenario where any host IHS has its OS is down (e.g., among other associated servers on the same local network of a data center), and critical data need to be read/written to or from that IHS. In a first step, the BMC of the IHS without a proper OS acts a slave BMC, and any other BMC in the group may act as a master BMC. The architectural implementation to enable access of virtual storage may follow either an NBD server-client or iSCSI server-client architecture depicted in the figures. An SCSI command initiator is set up by the master BMC. The transfer from master BMC to slave BCM may be an NBD server-client or iSCSI server-client mechanism, depending upon the implementation, and storage data is then transferred from slave BMC to master BMC via a network. Finally, data transfer from the master BMC to the OS of the master IHS may take place by mounting an NBD device as a virtual device to the master IHS.

Now consider a second scenario where a master BMC offloads a data transfer operation to a slave BMC. Again, the BMC without an OS will act as a slave and any other BMC in the group sets itself up as a master. The transfer between master BMC to slave BMC may use the NBD server-client or iSCSI server-client mechanisms, and storage data is then transferred from slave BMC to master BMC via a network. Data transfer from master BMC to virtual disk may take place over PCIe VDM channel to offload host processing.

Accordingly, the systems and methods described herein provide read/write of virtual storage of a server when the server's OS is down, among servers on the same local network. In various implementations, server storage read/write operations or data transfers are offloaded to the BMC in case of a PCIe VDM channel data transfer path. Through a group manager feature, a single master BMC can control data storage and transfer of multiple BMCs on same network. Furthermore, the examples of architectures described herein can be implemented with server-client technologies such ash NBD, SCSI over USB combination, or Internet SCSI and SCSI over USB combination, among others.

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. A Baseboard Management Controller (BMC) of an Information Handling System (IHS) having program instructions stored thereon that, upon execution, cause the IHS to:
communicate with another BMC of another IHS over a network; and
access a storage device of the other IHS through the other BMC via the network while the other IHS operates without any Operating System (OS).

2. The BMC of claim 1, wherein the BMC is configured to communicate with the other BMC bypassing the other IHS' Central Processing Unit (CPU).

3. The BMC of claim 1, wherein the other BMC is configured to transmit a read or write command issued by the BMC to a disk array controller of the other IHS.

4. The BMC of claim 3, wherein the disk array controller is configured to execute the read or write command with respect to a plurality of virtual drives maintained by the other IHS.

5. The BMC of claim 3, wherein the read or write command is transmitted to the disk array controller using the Management Component Transport Protocol (MCTP).

6. The BMC of claim 3, wherein the read or write command is transmitted to the disk array controller via a Management Engine (ME) using a PCIe Vendor Defined Message (VDM).

7. The BMC of claim 1, wherein the BMC includes a Network Block Device (NBD) client, wherein the other BMC includes an NBD server, and wherein the NBD client is configured to create a virtual hard drive on the IHS that corresponds to a physical hard drive on the other IHS.

8. The BMC of claim 1, wherein the BMC includes a Transmission Control Protocol/Internet Protocol (TCP/IP) network stack.

9. The BMC of claim 8, wherein the program instructions, upon execution, further cause the IHS to:
communicate with yet another BMC of yet another IHS over the network; and
access a storage device of the yet another IHS through the yet another BMC via the network while the yet another IHS operates without any Operating System (OS).

10. An Information Handling System (IHS), comprising:
a Baseboard Management Controller (BMC) distinct from any processor; and
a memory coupled to the BMC and having program instructions stored thereon that, upon execution by the BMC, cause the IHS to:
communicate with a plurality of other BMCs of a plurality of other IHSs; and
enable a user access to a plurality of storage devices coupled to the other IHS independently of the status of the other IHS's Operating Systems (OSs).

11. The IHS of claim 10, wherein the BMC is configured to communicate with the other BMCs bypassing the other IHS' Central Processing Units (CPUs).

12. The IHS of claim 10, wherein the other BMCs are each configured to transmit a read or write command issued by the BMC to a disk array controller of its respective IHS.

13. The IHS of claim 12, wherein the disk array controller is configured to execute the read or write command with respect to a plurality of virtual drives.

14. The IHS of claim 12, wherein the read or write command is effected using the Management Component Transport Protocol (MCTP).

15. The IHS of claim 12, wherein the read or write command is effected via a Management Engine (ME) using a PCIe Vendor Defined Message (VDM).

16. The IHS of claim 10, wherein the BMC includes a Network Block Device (NBD) client, wherein the other BMCs each includes an NBD server, and wherein the NBD client is configured to create virtual hard drives on the IHS that correspond to physical hard drives on the other IHSs.

17. The IHS of claim 10, wherein the BMC includes a Transmission Control Protocol/Internet Protocol (TCP/IP) network stack.

18. A method, comprising:
determining, by a first IHS, that a second IHS is operating without any Operating System (OS); and
sending, by a first Baseboard Management Controller (BMC) within the first IHS to a second BMC within the second IHS, an access request directed to a virtual drive of the second IHS, wherein the second BMC is configured to effect the access request without using any Central Processing Unit (CPU) of the second IHS.

19. The method of claim 18, wherein the access request is effected using the Management Component Transport Protocol (MCTP) or via a Management Engine (ME) using a PCIe Vendor Defined Message (VDM).

20. The method of claim 18, wherein the first BMC includes a Network Block Device (NBD) client, wherein the second BMC includes an NBD server, and wherein the NBD client is configured to create a virtual hard drive on the first IHS that corresponds to a physical hard drive on the second IHS.
